(19) United States
(12) Patent Application Publication
(10) Pub. No.: US 2007/0128400 A1
(43) Pub. Date: Jun. 7, 2007

(54) Disk divider

(76) Inventors: Sarah Pantaleo, Philadelphia, PA (US); Michael J. Leonard, Bala Cynwyd, PA (US)

Correspondence Address: WOLF GREENFIELD & SACKS, P.C., 600 ATLANTIC AVENUE, BOSTON, MA, 02210-2206, US

(21) Appl. No.: 11/292,429

(22) Filed: Dec. 1, 2005

(51) Int. Cl. B32B 3/02

(52) U.S. Cl. 428/45

(57) ABSTRACT

A divider for organizing and/or separating a plurality of disks stacked on a spindle storage device is provided. The divider includes a planar body having a tab portion which includes a surface for providing an identifier. The divider is constructed to be insertable and removable between adjacent disks stacked on a spindle without having to remove a disk from the spindle. The tab portion may be bendable or foldable with respect to the body portion of the divider so that the tab portion will conform to portions of the storage device. The divider may be used with spindles having either a horizontal or vertical orientation.

### FIELD OF INVENTION

The present application relates to a divider for separating and/or organizing disks on a spindle storage device.

### BACKGROUND OF INVENTION

Disks are generally used to store information, such as data, music, videos, etc., and they are used with various computers, media recorders and players. A disk may also be called by a unique different name depending on the information stored on it, its use, and format, (e.g. CDs, DVDs, etc.).

One approach to storing disks is in jewel cases, which are thin plastic boxes that typically only hold one or two disks. However, when storing a large number of disks, jewel cases may be cumbersome, may easily break, and may still require the use of another container to organize a plurality of disks.

Another approach to storing disks is to use a spindle storage device which includes a spindle sized to fit through an opening in the center of a disk. The spindle of a spindle storage device generally has either a horizontal or a vertical orientation. When the spindle has a vertical orientation, the storage device may include a flat base structure secured at one end of the spindle, and disks are stacked about the spindle, resting on the base structure. Spindle storage devices may store disks in a smaller space in comparison with jewel cases, and may also be cheaper to manufacture. Accordingly, blank disks are often packaged in spindle storage devices. These spindle devices may also be used for disk storage after information is saved or burned onto the disks. Spindles are also used to retain disks in a variety of types of disk storage devices. Therefore, even if a disk is originally packaged in a jewel case, it may subsequently be stored on a spindle device.

Because disks are used to store different types of information on one spindle, there is a need for a way to organize and separate the disks into categories. Some of the prior attempts to organize or separate disks are outlined below. However, as discussed below, these attempts are all accompanied by disadvantages upon which the present invention seeks to improve.

For example, U.S. Pat. No. 4,292,657 (Iwan et al.) and U.S. Pat. No. 4,148,084 (Gyi) are both directed to an apparatus for handling and partitioning disk recorded media. In particular, a plurality of flexible disks are provided, each having a tab engagement section along their periphery. These flexible disks are placed between recorded disks on a central rotatable spindle. A wedge assembly is brought into contact with the stack of disks, and is positioned adjacent one of the tabs. To separate the disks, the wedge is raised, causing the disks above the tab to move up the spindle, thereby separating a portion of the disks from the stack.

A similar device is described in U.S. Pat. No. 6,820,741 (Ferguson) which is directed to a disk storage and retrieval system. A plurality of disk media is stacked on a central spindle, and the disk media is modified with alignment protrusions and indexing notches. A particular disk of interest is indexed and retrieved from the stack by rotating a cover member to align the disk notch with a lifting device. The lifting device then raises a portion of the disks up the spindle.

U.S. Pat. No. 6,860,388 (Boorman) is directed to an optical disk holder which is designed to protect the recorded side of a disk. The disk holder is flat, has a circular body and a raised perimeter, and also has three radially aligned tabs. One disk snaps into each holder, and a plurality of holders can be stacked and secured together by mating protrusions and recesses in each tab.

U.S. Published Application No. 2003/0015440 (Downs) discloses a circular disk for insertion between laser disks to prevent surface scratching.

U.S. Published Application No. 2005/0060920 (Sharon) is directed to a filing system for compact disks. In particular, a disk-shaped carrier may include means for attaching a compact disk to the carrier, and a tab containing an indicia in reference to that compact disk. The carrier may include a pouch for holding the compact disk, and in one embodiment, the carrier is used with a spindle disk storage device.

### SUMMARY OF INVENTION

In one embodiment, a disk divider is provided. The divider includes a substantially planar body having a tab portion extending along at least a portion of the planar body, and the tab portion includes a surface for providing an identifier. The disk divider is constructed and arranged to be insertable and removable between adjacent disks stacked on a spindle without having to remove a disk from the spindle.

In a further embodiment, another disk divider is provided. The disk divider includes a substantially planar body, having a peripheral edge and an interior portion. The disk divider further includes a slot extending from the peripheral edge of the planar body into the interior portion of the planar body. The slot is constructed and arranged to removably position the divider about a spindle. A tab portion is proximate the peripheral edge of the planar body, and the tab portion includes a surface for providing an identifier.

In yet another embodiment, a method of organizing a plurality of disks stacked on a spindle storage device is provided. The method includes providing a plurality of disks, and a spindle storage device for storing the disks. Each disk has an opening therethrough, and the spindle storage device has a spindle sized and shaped to fit through the openings in the disks. The method further includes placing a plurality of disks on the spindle, and providing a substantially planar divider. The divider includes a tab portion for providing an identifier and an elongated slot extending from a peripheral edge into an interior portion of said divider. The divider is placed on the spindle, positioned between said plurality of disks, such that a portion of the elongated slot at least partially surrounds the spindle, and the divider is removed from the spindle without removing a disk from the spindle.

### BRIEF DESCRIPTION OF DRAWINGS

The foregoing and other objects and advantages of the present invention will be appreciated more fully from the following drawings, wherein like reference characters designate like features, in which:

FIG. 1 is a top plan view of a disk divider in accordance with one illustrative embodiment of the present invention;

FIG. 2 is a perspective view of a disk divider in accordance with one illustrative embodiment of the present invention being inserted into a spindle disk storage device;

FIG. 3 is a perspective view of the disk divider and spindle disk storage device illustrated in FIG. 2 with a protective cover over the spindle storage device;

FIG. 4 is a side view of a disk divider and spindle disk storage device in accordance with one illustrative embodiment of the present invention;

FIG. 5 is a top plan view of a disk divider with a storage device similar to the embodiment illustrated in FIG. 4;

FIG. 6 is a top plan view of a disk divider in accordance with one illustrative embodiment of the present invention;

FIG. 7 is a top plan view of a disk divider in accordance with one illustrative embodiment of the present invention;

FIG. 8 is a perspective view of a plurality of disk dividers, a spindle disk storage device, and a plurality of disks in accordance with yet another illustrative embodiment of the present invention;

FIG. 9 is a top plan view of a plurality of disk dividers in accordance with one embodiment of the present invention; and

FIG. 10 is a top plan view of a plurality of disk dividers in accordance with one embodiment of the present invention.

### DETAILED DESCRIPTION

Applicants have recognized that a limitation in the prior approaches to separating or organizing disks is that all fail to allow the organization of disks to easily change. Applicants recognized that to the extent that any of the above references separate or divide a stack of disks, these attempts do not provide a separator or divider that can be inserted or removed between disks which does not also involve removing disks from the spindle. This feature of the present invention is advantageous because it enables a user to easily alter the organization of a stack of disks.

Aspects of this invention are directed to a disk divider for use with a spindle disk storage device, where the divider is arranged to be insertable and removable between adjacent disks stacked on a spindle, without having to remove a disk from the spindle. The disk divider may include a tab portion which includes a surface for providing an identifier. The identifier may be a permanent or removable label or indication of the type of disks arranged proximate the divider. The tab portion and the identifier permit a user to easily see multiple categories of disks on a spindle, without having to look at the disks. Other aspects of the invention are directed to a method of organizing and separating a stack of disks on a spindle storage device.

Turning now to the drawings, it should be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one figure, and/or may also encompass embodiments combining components illustrated in multiple different drawings.

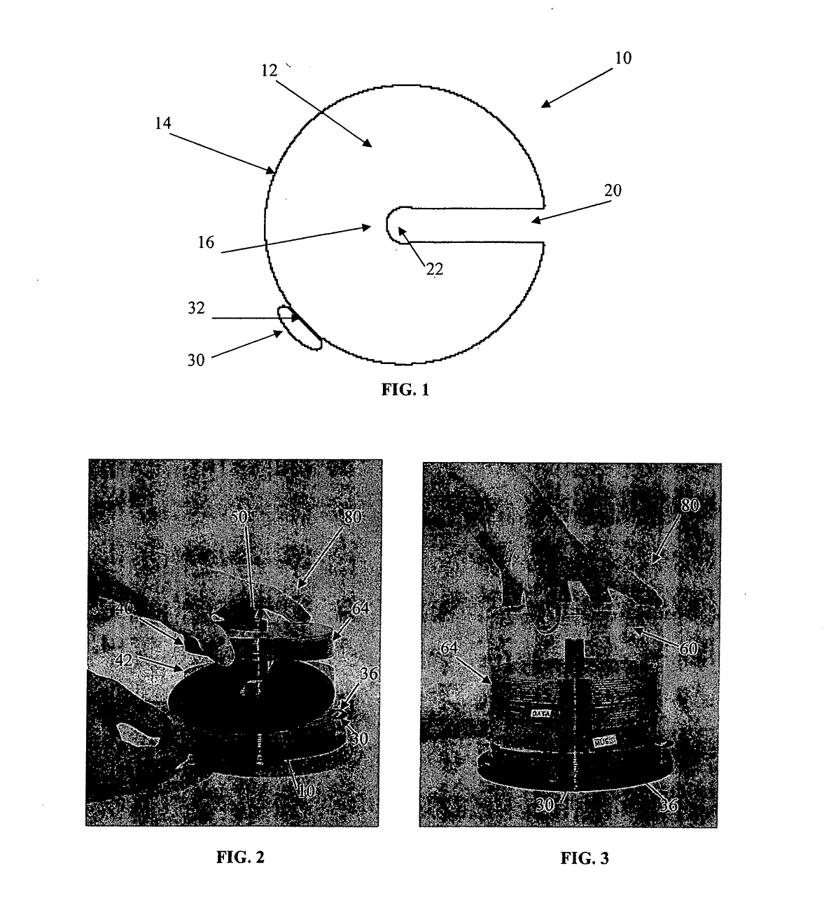

In FIG. 1, a disk divider 10 is illustrated. The disk divider 10 includes a substantially planar body 12 which has a slot 20 extending from the peripheral edge 14 of the planar body into the interior portion 16. The divider 10 is sized to fit with a spindle disk storage device. For example, the slot 20 is constructed to removably position the divider 10 about a spindle. The slot 20 may terminate into a semi-circular opening 22 in the interior portion 16 of the body 12. A tab portion 30 may further be provided proximate the peripheral edge 14 of the planar body 12. The tab portion 30 includes a surface for providing an identifier or label to correspond to the adjacent disks. As discussed in further detail below, an identifier may be any type of marking which indicates a different category of disks. Furthermore, there may be a fold line 32 positioned between the tab portion 30 and the body portion 12. As discussed more below, the fold line 32 enables the tab portion 30 to bend or fold with respect to the rest of the divider 10. By folding the tab portion, an identifier on the tab portion 30 may be more visible when viewing the disk divider from an angle or orientation other than a top view. For example, when the tab portion is folded about fold line 32, the tab portion and identifier may be more visible from a side view.

In the embodiment illustrated in FIG. 1, the divider is substantially circular in shape, but the invention is not so limited. The divider may have a different shape, such as square, rectangular, oval, etc., or it may have an irregular shape. However, it may be desirable when all, or most, of the edges of the divider 10 are rounded to prevent the divider 10 from scratching disks during either the insertion or removal of the divider 10 from a stack of disks.

As shown in FIG. 1, the slot 20 is formed with two substantially parallel edges extending from the peripheral edge 14 and into the interior portion 16. However, it should be appreciated that the slot 20 may be shaped differently, such as with non-parallel and/or curved edges, as the invention is not so limited. Also, as shown in FIG. 1, the slot 20 may terminate into a central opening 22 in the center of the divider 10. It should be appreciated that the slot 20 may also terminate at an off-center position. Furthermore, in FIG. 1, the tab portion 30 protrudes out from the general shape of the body portion 12 of the divider 10. However, the shape and size of the tab portion 30 may vary, as the invention is not so limited. For example, the tab portion may extend around a greater portion of the body portion 12. Also, tab portion 30 may form a more fluid shape with the body portion 12, such that the body portion 12 and the tab portion 30 have a similar contour.

FIG. 2 illustrates one method in which a disk divider 10 is utilized with a spindle storage device 80. The divider 10 may be positioned at one end of the spindle 50 with the slot 20 aligned with the spindle 50. Then, the divider 10 may slide along the spindle until it contacts a disk on the spindle 50. However, as shown in FIG. 2, the divider 10 may also be inserted between disks 40, 42 that are already on a spindle 50. The divider 10 is positioned between two adjacent disks 40, 42 with the entrance into the slot 20 facing the spindle 50. By sliding the slot 20 of the divider 10 towards the spindle 50, the divider 10 is positioned between two disks. As shown in FIG. 2, to insert a divider 10 between disks 40, 42, the disks positioned adjacent the desired location for the divider 10 may slide along the spindle to create more room for the insertion of the divider 10. As shown in FIG. 1, to prevent the divider 10 from slipping off the spindle, the slot may terminate into a shape that is similar to the size and shape of the spindle 50. The slot may also terminate into a shape that is slightly smaller than the shape of the spindle 50 to help retain the divider on the spindle 50. Many spindles for carrying disks have a circular cross-section, therefore the slot 20 (shown in FIG. 1) terminates in a circular opening 22. However, it should be appreciated that the slot 20 may terminate in other shaped openings, as the invention is not so limited.

FIGS. 2-3 illustrate the divider 10 being used with a spindle 50 having a generally vertical orientation, but the invention is not so limited. The divider 10 may also be used with spindles 50 having a generally horizontal orientation or with spindles having any angled orientation. Therefore, a stack of disks may refer to not only a vertical stack but also to other stack orientations, such as a horizontal stack, as the invention is not so limited.

FIGS. 2-5 illustrate some of the beneficial features of the tab portion 30. In particular, once the divider 10 is inserted into the stack of disks 64, the tab portion 30 is still visible, which allows a user to see an identifier 36 on the tab portion 30. In FIGS. 2-3, the identifier 36 is a label. One side of the label has an adhesive which adheres to the tab portion 30, and the other side of the label has a writing surface on which words or symbols may be written or printed. However, as discussed in further detail below, the identifier may also be constructed differently.

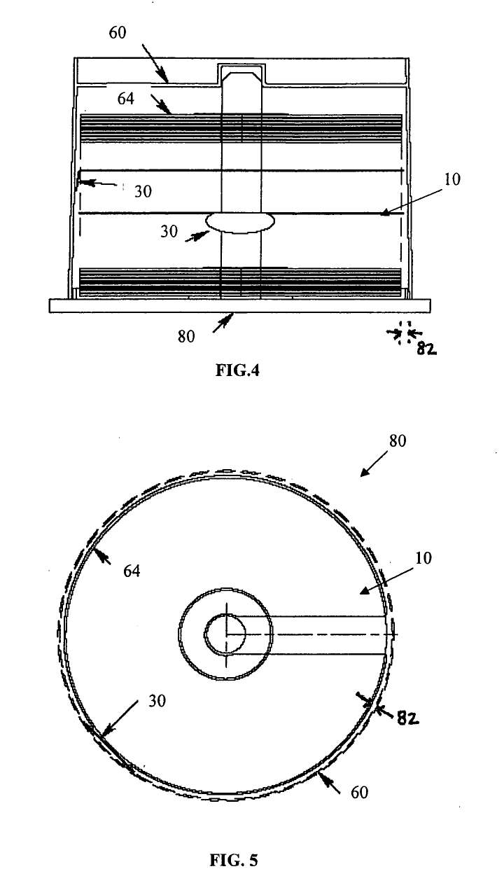

As shown in FIGS. 3-5, the tab portion 30 may be foldable about a fold line 32. In these figures, the spindle 50 of the storage device 80 has a generally vertical orientation. When a protective lid or cover 60 is placed over the spindle storage device 80, the tab portion 30 may bend downwardly. In particular, due to the size of the divider 10 relative to the size of the cover 60, the tab portion 30 may fold downwardly from pressure acting on the tab portion 30 by the cover 60. This may be advantageous because it may make the identifier 36 on the tab portion 30 more visible from a side view of the storage device 80, as illustrated in FIGS. 3-4. It may also help to allow the divider 10 to be used with a variety of sized spindle disk storage devices. Many conventional disk storage devices which include a protective cover 60 are sized for minimal clearance 82 between the two components, as illustrated in FIGS. 4-5. A divider 10 having a foldable or bendable tab portion 30 may be used with these conventional storage devices, even if the width of the tab portion 30 is greater than the width of the clearance 82.

A foldable tab portion 30 may also be beneficial when the spindle 50 of the storage device 80 has a generally horizontal orientation or when the spindle has any other angled orientation, because it may enable a user to see the identifier 36 from other views. It should be appreciated that when the disk divider is used with a spindle storage device having a spindle 50 not having a generally vertical orientation, the identifier on the tab portion 30 may be positioned differently, such that it is easier to view in that orientation.

As mentioned above, the identifier 36 may be provided on the tab portion 30 in a variety of ways. For example, the identifier 36 may be either permanent or erasable. The tab portion 30 may include an erasable surface such as a whiteboard or chalkboard surface. An erasable writing instrument, such as a whiteboard marker or chalk may be used to provide an identifier or label for the divider 10. In this respect, the user may design his/her own identifiers 36 based on his/her particular disk collection. The user may also easily change the categories by erasing the identifier 36. Alternatively, sticker-like labels may be provided. A user may designate a more permanent identifier 36 onto the labels with a writing instrument such as a pen or marker. A plurality of blank labels may be provided on one sheet, which may be arranged so that a user can easily print identifiers onto the sheet of blank labels. Furthermore, a variety of identifiers 36 may be pre-printed onto labels that a user may apply to the tab portion 30. For example, pre-printed labels may be provided with the dividers 10 having identifiers such as “Blank”, “Data”, and “Music”, etc., but the invention is not so limited. Any possible labels are suitable for use.

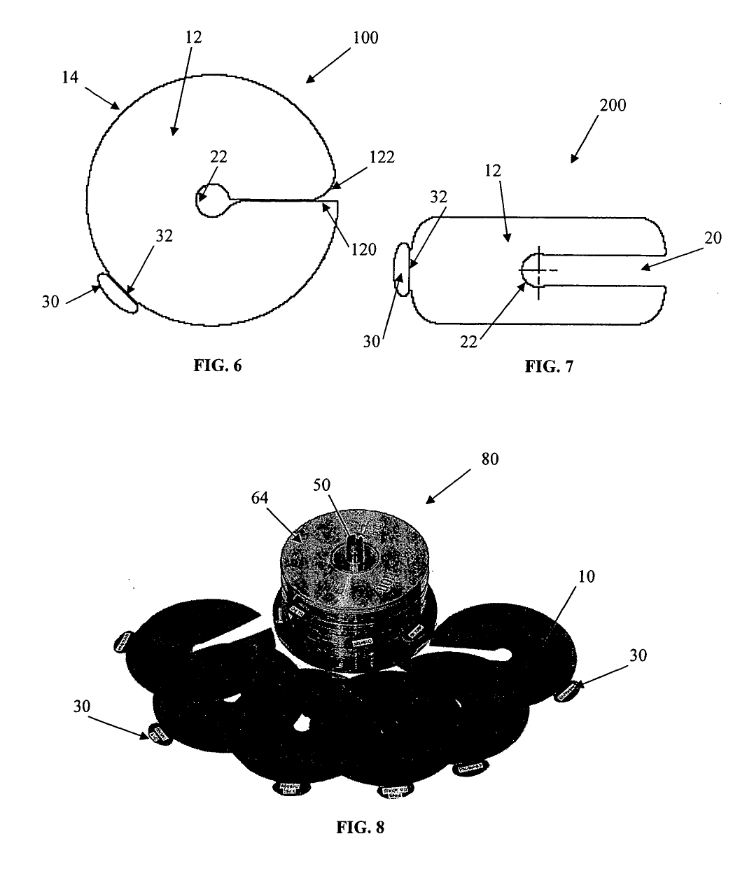

Turning to FIGS. 6-7, disk dividers having different constructions are disclosed. For example, FIG. 6 illustrates a disk divider 100, similar to the disk divider 10 of FIG. 1, except that the slot 120 is shaped differently. In particular, slot 120 is smaller in width than slot 20. A more narrow slot 120 may be advantageous if it is desirable for the disk divider 100 to have a stronger hold on the spindle 50. When the size of the spindle 50 does not change, the wider the slot 120, the easier the divider will slide on or off of the spindle 50. When the width of the slot 120 is less than the width of the spindle, portions of the divider must be flexed or pulled away from the slot to allow the divider to encompass the spindle 50.

As mentioned above, the slot 120 may be sized and shaped in a variety of configurations. In FIG. 6, the slot has two generally parallel edges, however, a portion of one of the edges 122 curves away from the other edge near the peripheral edge 14 of the divider 100. This design may make it easier for a user to separate the two parallel edges from each other to accommodate the size of the spindle 150 either during insertion or removal of the divider 100. The slot may also be formed with non-parallel and/or curved edges, as the invention is not so limited.

FIG. 7 shows a divider 200 similar to the divider 10 shown in FIG. 1, except that the divider 200 is smaller, and the shape of the peripheral edge 14 has both rounded and linear sections. The embodiment illustrated in FIG. 7 may be beneficial because it reduces the total amount of material required for manufacturing one divider 200. As shown, the body portion 12 is somewhat oval or rectangular shaped, and the peripheral edge 14 of the divider 200 has two substantially parallel edges opposite each other, but the invention is not so limited. It should be appreciated that the overall size of the divider 200 and the shape of its peripheral edge may vary.

According to one aspect of the present invention, a plurality of disk dividers 10 is provided for use with a plurality of disks 64 and a spindle disk storage device 80. For example, as shown in FIG. 8, nine dividers 10 are provided, but the invention is not so limited. Five, ten, fifteen, twenty or more dividers 10 may be provided. Each divider may be identical except for having a different identifier 36 on the tab portion 30 of the divider 10. Once the dividers are positioned with respect to the storage device 80, the dividers 10 may be rotated about the spindle 50 such that the tab portions 30 are positioned radially at different locations so that each tab portion 30 may be viewed from a common viewpoint without blocking the view of another tab portion.

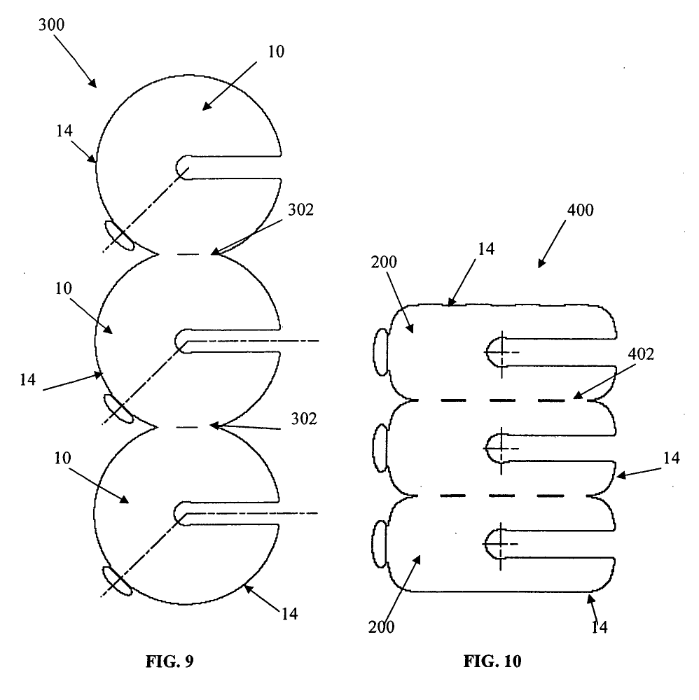

The divider 10, 100, 200 of the present invention may be manufactured in a variety of ways and from various materials. In one embodiment, the dividers are die-cut from plastic or paper. When the dividers are die-cut, a sheet of material may be used to form a plurality of dividers. To minimize the amount of material required, as shown in FIGS. 9 and 10, a plurality of dividers may be formed together. For example, in FIG. 9, a sheet of material 300 is cut into shapes corresponding to a plurality of dividers. In this particular embodiment, three dividers 10 are formed together, but the invention is not so limited. For example, two or more dividers may be formed together.

As shown in FIG. 9, a portion of each divider is secured to an adjacent divider along its peripheral edge. Fold lines 302 may be provided along the peripheral edges of the dividers 10 so that the plurality of dividers 10 may be folded over onto one another like an accordion. This configuration may be ideal for packaging. Perforations may also be provided on the fold line 302 to make it easier to detach the dividers 10 from one another for use. Similarly, FIG. 10 also illustrates a sheet of material 400 which is cut into shapes corresponding to a plurality of dividers 200. These dividers 200 are similar to those shown in FIG. 7. Fold lines 402 extend along a larger region of each divider 200 to separate one divider 200 from another.

It is contemplated that the disk divider of the present invention may be made from materials such as paperboard, vinyl, or polypropylene. A coating may be applied to one or both sides of the divider to prevent the divider from tearing and/or for making the divider more liquid-resistant. It should be appreciated that when the tab portion 30 of the divider is foldable or bendable with respect to the body portion 12 of the divider, the divider may be made of a flexible or pliable material. Alternatively, the tab portion 30 may be foldable with respect to the body portion of the divider with a hinge, such as a living hinge at the fold line 32. Also, the dividers may all be the same color, or a plurality of dividers may be made from multiple colors, as the invention is not so limited. Furthermore, the material of the dividers may range from clear, to translucent to opaque.

The size and shape of a divider may vary, as the invention is not so limited. For example, the divider may have a size and shape similar to a conventional CD or DVD. As shown in FIG. 1, the body portion 12 of the divider may be substantially circular in shape with a diameter of about 4.75″. The slot 20 may extend into the center of the interior portion 14 and may have a width of about 0.56″. At the end of the slot 20, there may be a circular opening 22, as shown in FIG. 1, which may have a diameter of about 0.58″ or more so that it can encompass conventional spindles. The slot 20 may be slightly rounded near the edge 122 of the divider, and may for example, have a radius of curvature of about 0.06″. It should be appreciated that these dimensions are merely illustrative, as the invention is not limited in this respect. The dimensions of the divider may also depend upon the size and shape of the cross-section of the spindle.

The thickness of the divider may also vary, as the invention is not so limited. The thickness may be about 0.015″. When the thickness is greater than about 0.015″ it may be more difficult for the tab portion 30 to bend with respect to the body portion 12 of the divider. However, if a hinge is positioned between the tab portion 30 and the body portion 12, the thickness of the body portion and/or the tab portion may be greater than 0.015″. Some materials are also more flexible than others. Therefore, if a more flexible material is used, the material thickness may be greater than about 0.015″ while still allowing for flexure and bending.

As mentioned above, the tab portion 30 may be configured in different ways, but as shown in FIG. 1, the tab portion 30 may protrude out from the body portion 12 in an oval shape, but the invention is not so limited. The tab portion 30 may be shaped differently, such as square, rectangular, circular, or of an irregular shape. Alternatively, the tab portion 30 may be a more gradual extension of the body portion 12, such that the tab portion 30 follows the same or a similar contour as the body portion 12. The tab portion may extend away from the body portion 12 such that the width of the tab portion 30 is about 0.3″. In this configuration, when the tab portion 30 is folded downwardly, it is sized to cover about four standard sized disks. It should be appreciated that the tab portion 30 may cover more or less disks in a folded state. The width of the tab portion 30 may vary, but it should be large enough to provide a space for an identifier 36. Furthermore, the tab portion 30 may also be the portion of the divider that a user grips when either inserting or removing the divider into a spindle storage device (see FIG. 2). Therefore, the tab portion 30 may be large enough for a user to handle.

The position of the tab portion 30 with respect to the slot 20 may also vary, as the present inventor is not so limited. However, as shown in FIG. 1, the tab portion 30 is approximately 135° away from the slot 20. Alternatively, the tab portion may be positioned 90°, 180°, 270°, etc., away from the slot.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A disk divider comprising:
a substantially planar body having a tab portion extending along at least a portion of said planar body, wherein said tab portion includes a surface for providing an identifier;
wherein said divider is constructed and arranged to be insertable and removable between adjacent disks stacked on a spindle without having to remove a disk from the spindle.

2. The disk divider of claim 1, wherein said divider includes a slot which leads into a central opening, said slot extending from the peripheral edge of said planar body.

3. The disk divider of claim 2, wherein said central opening is substantially circular shaped.

4. The disk divider of claim 1, wherein said planar body has at least one dimension substantially equivalent to a diameter of a disk.

5. The disk divider of claim 1, further comprising an identifier, wherein said identifier includes a label having a writing surface and an adhesive surface, wherein said adhesive surface is secured to said tab portion.

6. The disk divider of claim 1, wherein said surface for providing an identifier includes a whiteboard surface.

7. The divider of claim 1, further comprising a fold line between said tab portion and said body such that said tab portion is bendable with respect to said body.

8. A disk divider comprising:
a substantially planar body, said planar body have a peripheral edge and an interior portion;
a slot extending from the peripheral edge of said planar body into the interior portion of said planar body, said slot constructed and arranged to removably position said divider about a spindle; and
a tab portion proximate the peripheral edge of said planar body, wherein said tab portion includes a surface for providing an identifier.

9. The disk divider of claim 8, wherein said planar body has at least one dimension substantially equivalent to a diameter of a disk.

10. The disk divider of claim 8, wherein the peripheral edge of said planar body is substantially circular in shape.

11. The disk divider of claim 8, wherein said tab portion further comprises an identifier, wherein said identifier includes a label having a writing surface and an adhesive surface, wherein said adhesive surface is secured to said tab portion.

12. The disk divider of claim 8, wherein said surface for providing an identifier includes a whiteboard surface.

13. The disk divider of claim 8, wherein said slot terminates in substantially the center of said planar body.

14. The disk divider of claim 8, wherein said slot terminates in a substantially circular opening.

15. The disk divider of claim 8, in combination with a spindle storage device.

16. The disk divider of claim 15, wherein a spindle on said spindle storage device is oriented in a vertical orientation.

17. The disk divider of claim 8, in combination with a plurality of disks.

18. The disk divider of claim 8, wherein said substantially planar body is made from a flexible material.

19. The disk divider of claim 8, further comprising a fold line between said tab portion and said body such that said tab portion is bendable with respect to said body.

20. A method of organizing a plurality of disks on a spindle storage device, the method comprising:
providing a plurality of disks, wherein each disk has an opening therethrough;
providing a spindle storage device for storing said disks, wherein said spindle storage device has a spindle sized and shaped to fit through the openings in said disks;
placing a plurality of disks on said spindle;
providing a substantially planar divider, wherein said divider includes a tab portion for providing an identifier and an elongated slot extending from a peripheral edge into an interior portion of said divider;
placing said divider on said spindle, positioned between said plurality of disks, such that a portion of said elongated slot at least partially surrounds said spindle; and
removing said divider from said spindle without removing a disk from the spindle.

21. The method of claim 20, further comprising:
providing a plurality of substantially planar dividers, each divider having a tab portion and an elongated slot;
providing an identifier on said tab portions of said dividers; and
inserting said plurality of dividers on said spindle, by sliding said dividers between said plurality of disks.

22. The method of claim 20, further comprising:
providing a cylindrical shaped protective cover for placing over said spindle storage device;
providing a fold line on said divider adjacent said tab portion;
providing an identifier on said tab portion of said divider;
placing said protective cover over said spindle storage device after said plurality of disks and said divider are placed on said spindle, wherein said cover contacts said tab portion such that said tab portion bends downwardly about said fold line.
